(19) United States
(12) Patent Application Publication
(10) Pub. No.: US 2008/0172737 A1
(43) Pub. Date: Jul. 17, 2008

(54) Secure Electronic Medical Record Management Using Hierarchically Determined and Recursively Limited Authorized Access

(76) Inventors: Jinmei Shen, Rochester, MN (US); Hao Wang, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/622,065

(22) Filed: Jan. 11, 2007

(51) Int. Cl. H04L 9/32

(52) U.S. Cl. 726/21

(57) ABSTRACT

A method and system for providing secure access to a patient's medical records. In one embodiment, an access authorization account is received that specifies access parameters relating to the patient's medical records. The access authorization account specifies: an authorized user identification that specifies one or more user identification codes that may be utilized to access the patient's medical records; content scope authorization that specifies the scope of data content within the patient's medical records that is accessible using the authorized user identification; content access authorization that specifies the extent to which the accessible data content is modifiable using the authorized user identification; and an access period that specifies an access termination time. The access authorization account is processed by an access manager to determine and implement limited access to the patient's medical records.

### BACKGROUND OF THE INVENTION

1. Technical Field

The present invention relates generally to electronic medical records, and in particular, to a remotely managed and accessed distributed electronic medical record system. More particularly, the present invention relates to a system and service architecture for providing single-source-controlled and distributed managed remote access by both patients and medical providers to electronically stored patient medical records.

2. Description of the Related Art

Medical records systems for generating and maintaining patient medical data electronically are known in the art. Security and convenient distributed access continue to pose challenges for such systems. A given patient over her/his lifetime may seek medical care and treatment for emergencies, ongoing non-urgent conditions, and maintenance of good health. Such diverse care is provided from a broad range of healthcare providers, diverse in specialty as well as geographic location. The geographic and temporal discontinuous incident to provision of medical care results in the patient's medical records being substantially inaccessible and unmanageable by the patient and often the medical community at large. Even when access to medical records is provided to the patient, the dissimilar forms and formats used by various healthcare providers makes it largely impracticable to store the records at a centrally accessible source in an electronic format.

Typically, medical record management systems have been established and maintained by large scale computers within a healthcare provider's locality, e.g., office complex, hospital, laboratory, etc. Conventional medical record management systems provide very limited patient access to her/his own medical records. Such access is severely limited to specified times and locations such as when a patient is corporally present at a hospital. Such severe medical record access limitations results in substantial risks of miscommunication and/or misunderstandings relating to past and ongoing medical issues. Also, issues of patient privacy and concerns for privacy and data access arise, particularly in large systems.

Security is the primary limiting factor resulting in the limited access to patients' medical records. In this respect, access to and maintenance of human medical records differs from most other data management enterprises such as for pet health records, supply chains, on-line shopping, and libraries. Failure to implement robust, distributed access to medical data records is largely due to the risk of lawsuits arising from failures to maintain adequately secure access to the records. Therefore, while the technology has been developed for storing medical records electronically, the use and implementation of electronic medical records has not developed significantly beyond the traditional physician-controlled medical record system based on paper medical records.

In addition to the threat of lawsuits by individual patients, electronic medical record dissemination is further complicated by various regulatory and legal mandates such as the Health Information Portability and Accountability Act of 1996 (HIPAA) which have heightened medical data handling requirements in an effort to protect patient privacy and medical confidentiality. Healthcare information management professionals are now confronted with an array of procedural and substantive requirements that are intended to ensure that patients' medical information is protected from inappropriate disclosure to unauthorized parties or entities. Various medical record management systems have therefore been developed in an attempt to securely manage private patient medical records.

A substantial portion of medical data management directly relates to limiting and recording access to patients' electronic medical records. Various medical record management systems include features that facilitate publishing or dissemination of medical records. These systems further include features for tracking and recording release of information requests by health insurers and other entities. Other medical record management functions include capturing and recording patient information release consents and archiving information requests. However, none of the prior art systems provides user-centric, top-down management in which patients may access and control access while further enabling the patients to delegate access authority.

As developing information technology has allowed more and more personal data to be collected, stored, used, and often even sold, privacy concerns of patients have assumed more importance. Many of the prior art electronic medical record systems have included mechanisms to provide some amount of privacy for patients by limiting access to medical records to authorized medical personnel, but have not allowed patients to decide which medical personnel will be authorized.

Conventional electronic medical record management systems fail to provide adequately flexible access by the patient and the patient's healthcare providers to her/his own medical records. Therefore, a need exists for an individualized electronic medical record management system for providing a patient and the patient's healthcare providers with flexible and comprehensive access without compromising security of sensitive medical information. The present invention addresses this and other needs unresolved by the prior art.

### SUMMARY OF THE INVENTION

A method and system for providing secure access to a patient's medical records are disclosed herein. In one embodiment, an access authorization account is received that specifies access parameters relating to the patient's medical records. The access authorization account specifies: an authorized user identification that specifies one or more user identification codes that may be utilized to access the patient's medical records; content scope authorization that specifies the scope of data content within the patient's medical records that is accessible using the authorized user identification; content access authorization that specifies the extent to which the accessible data content is modifiable using the authorized user identification; and an access period that specifies an access termination time. The access authorization account is processed by an access manager to determine and implement limited access to the patient's medical records.

The above as well as additional objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a high-level block diagram of a networked medical records management system in accordance with one embodiment of the present invention;

FIG. 2 is a block diagram depicting a data processing system that may be implemented as a server in accordance with a preferred embodiment of the present invention;

FIG. 3 is a block diagram illustrating a data processing system in which the present invention may be implemented;

FIG. 4 is a block diagram depicting in greater detail an exemplary architecture for medical records management system 100 adapted for implementing hierarchically determined and recursively limited authorized access in accordance with the present invention;

FIG. 5A illustrates an exemplary collection of medical records in accordance with one embodiment of the present invention;

FIG. 5B depicts a temporal account object generated by a medical records access manager using validated request parameters in accordance with one embodiment of the present invention;

FIG. 6 is a high-level block diagram showing hierarchically recursive authentication/authorization of access to medical records in accordance with the present invention;

FIG. 7 is a high-level flow diagram depicting steps performed by components within a medical records management system during a medical record access sequence in accordance with one embodiment of the present invention;

FIG. 8 is a high-level flow diagram illustrating sub-account independent authentication and authorization in accordance with the invention;

FIG. 9 is a high-level flow diagram depicting dependent automatic batch authentication and authorization using temporal accounts; and

FIG. 10 is a high-level flow diagram illustrating emergency personnel authentication and authorization in accordance with one embodiment of the present invention.

### DETAILED DESCRIPTION OF ILLUSTRATIVE EMBODIMENT(S)

The present invention is generally directed to managing access to healthcare information in a manner providing patients/providers secure and flexible access to and control of medical record data. In one aspect, the present invention is a system and service architecture for centrally managing access to electronic patient medical records in a manner enabling top-down controlled remote access by both patients and medical providers over a public network.

The medical record management system and method of the present invention enable remote access to electronically stored patient medical records by various healthcare provider entities as well as the patients themselves. Patients may control access to their medical records by using a unique and secure access identification means to set access parameters appropriately. As used herein, the term “medical,” “health,” and “healthcare” as applied to data records and persons or entities refers to generally accepted health-related areas served by physicians, pharmacists, physical or psychological therapists, emergency medical technicians, dentists, laboratory clinicians, nurses, and all other disciplines relating to health or medicine.

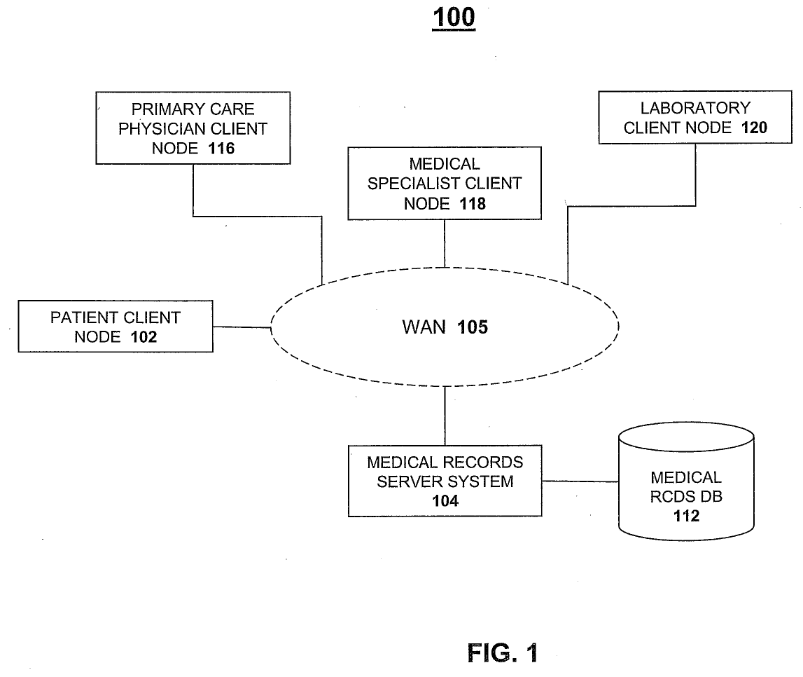

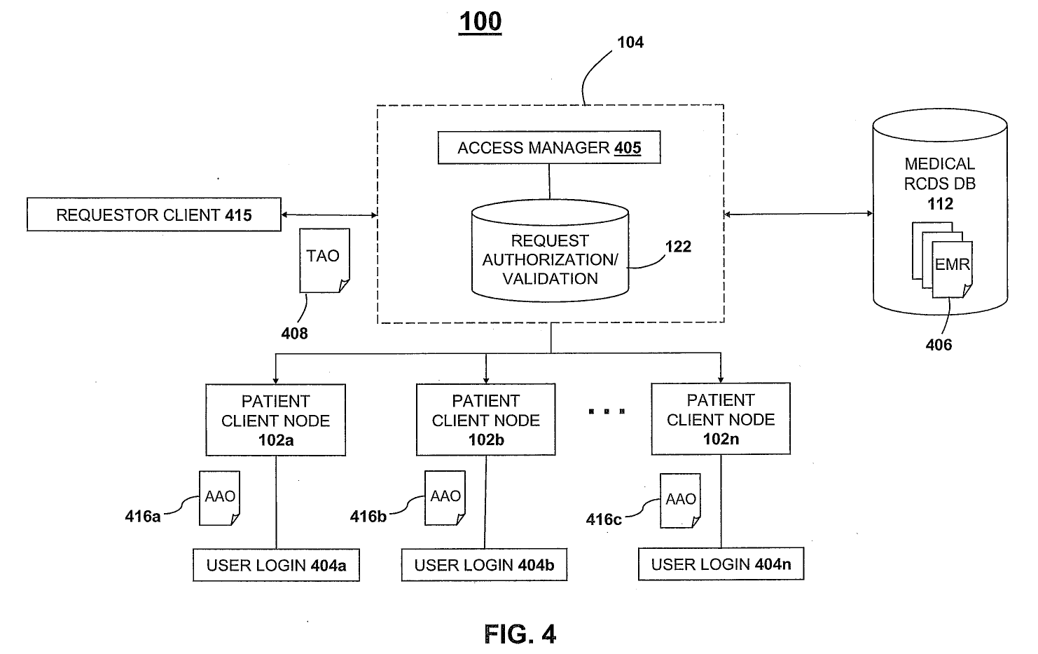

With reference now to the figures, wherein like reference numerals refer to like and corresponding parts throughout, and in particular with reference to FIG. 1, there is depicted a high-level block diagram of a networked medical records management system 100 in accordance with one embodiment of the present invention. Medical records management system 100 provides remote access to electronic medical records by patients and authorized healthcare providers via a network, such as the Internet, using ordinary browser software. In practice, users/patients may register with the service architecture of the present invention to have their medical records electronically stored in a medical records database 112 and managed in accordance with the techniques disclosed herein. Medical records database 112 is communicatively coupled to a medical records server 104, which as explained in further detail below with reference to FIG. 4, includes access management functionality for providing secure top-down controlled access to data within medical records database 112. Medical records server 104 is communicatively connected to a wide area network (WAN) 105, which may be the Internet.

Multiple client nodes are coupled to WAN 105 including a patient client node 102 and healthcare provider client nodes 116, 118, and 120. More specifically, and as depicted in FIG. 1, provider nodes 116, 118, and 120 represent a primary care physician node, a specialist node, and a lab client node, respectively. Patient client node 102 and provider client nodes 116, 118, and 120 comprise hardware platforms which may be in the form of personal computers, handheld personal computing devices, or other browser-enabled platforms capable of uploading and downloading and processing medical data contained within medical records database 112. Each of client nodes 102, 116, 118, and 120 includes user input/output (I/O) devices for inputting user and account identification data as well as for viewing and modifying medical records data.

As explained in further detail below, medical records management system 100 provides a client server application that controls access to the individual per patient medical data contained within medical records database 112. Specifically, the application provides a hierarchical medical records access control mechanism whereby a single top level source, such as the patient him/her self, specifies a conditionally-defined top level access which in turn provides recursively limited authorized access to lower access levels such as may be defined by various identities or categories of healthcare providers. In accordance with the invention, the conditions defining the top and lower level access include a temporal limitation, data scope limitation, and data processing permissions (e.g. read/write).

Medical provider clients 116, 118, and 120 may access and process medical records data within medical records database 112 as authorized by temporal and otherwise conditioned medical records access permissions granted by patient node 102, which utilizes a patient login module to specify medial records accessibility. For example, the recursively limited access control may enable a cardiovascular specialist at provider node 118 to have access to health history information relating to the physical but not the psychological condition and history of a given patient. As another example, the invention provides a system that reduces the likelihood of medication and dosage mistakes when one of the healthcare provider clients is a pharmacy client node. In another aspect, the present invention enables a patient at patient client node 102 to approve access to their medical records for medical research, such as pharmacological studies. Once such access is established such as via an access authorization account described in further detail hereinbelow, the appropriately authorized access to medical records enables timely reporting of diagnostic test results from labs or other research and/or treatment facilities to physicians and to patients. A medical provider at one of provider nodes 116, 118, 120 or other nodes may request expanded access to specified medical information which may or may not be granted such as from patient client node 102 using the mechanisms described herein.

Providers and patients at any of the client nodes may access the records within medical records database 112 using encryption protected web browsers and may further utilize server-type software tools such as Java applets to provide various graphical and textual access. The hardware platforms for client nodes 102, 116, 118, and 120 may include but are not limited to PCs, hand-held computers, wireless phones, vehicle-mounted computers, etc.

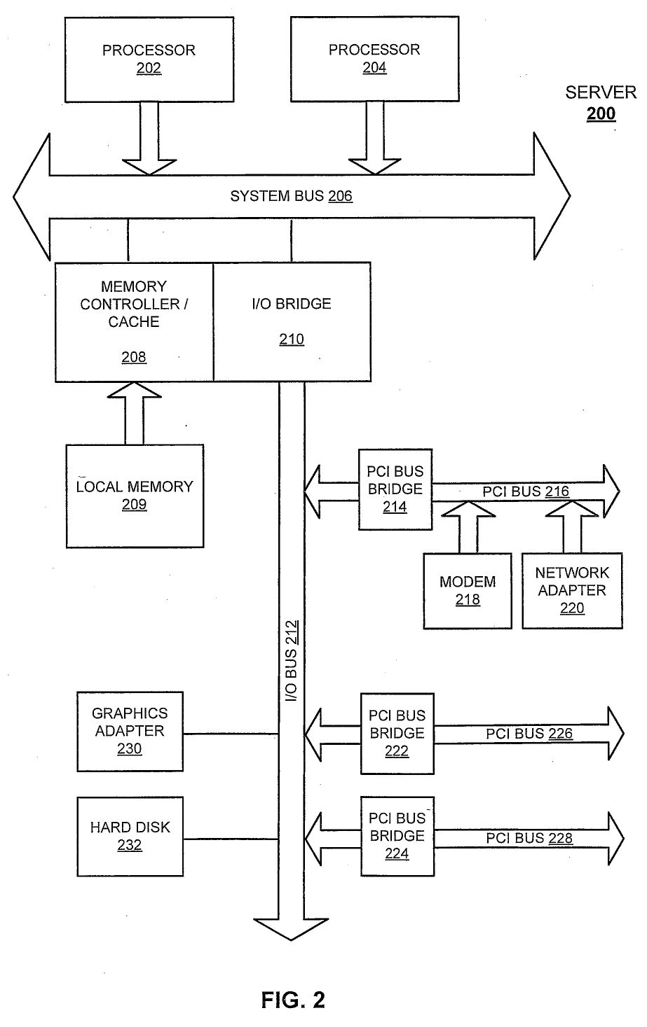

Referring to FIG. 2, there is illustrated a block diagram of a server system 200 that may be implemented as medical records server 104 in FIG. 1, in accordance with the invention. Server system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

A peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to client nodes 102a-102n in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer™ pSeries® system, a product of International Business Machines Corporation in Armonk, N.Y., running the Advanced Interactive Executive (AIX™) operating system or LINUX operating system.

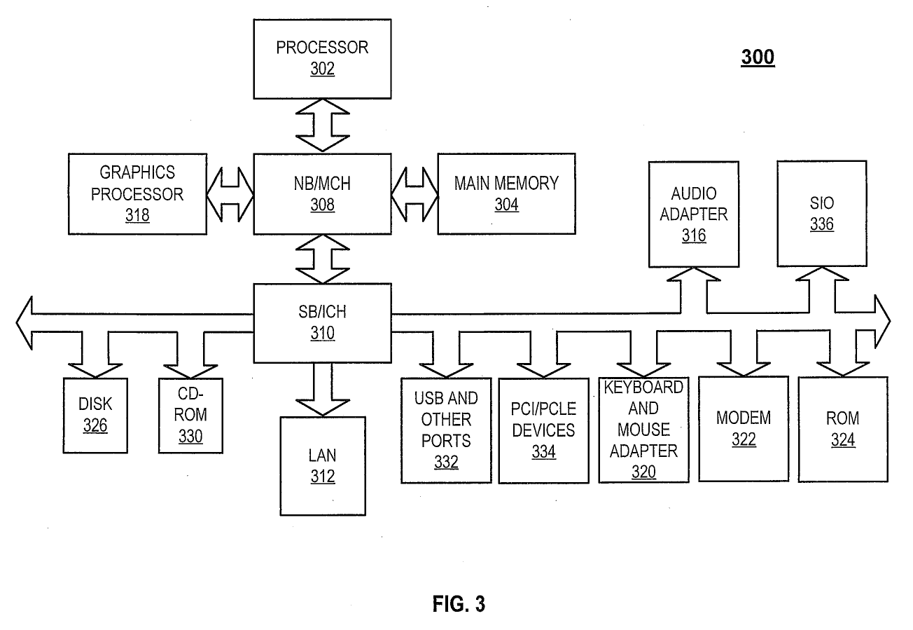

With reference now to FIG. 3, a block diagram of a data processing system is shown in which features of the present invention may be implemented. Data processing system 300 is an example of a computer, such as medical records server system 104 and/or one or more of client node 102, 116, 118, and 120 in FIG. 1, in which code or instructions implementing the processes of the present invention may be stored and executed. In the depicted example, data processing system 300 employs a hub architecture including a north bridge and memory controller hub (MCH) 308 and a south bridge and input/output (I/O) controller hub (ICH) 310. Processor 302, main memory 304, and graphics processor 318 are connected to MCH 308. Graphics processor 318 may be connected to the MCH through an accelerated graphics port (AGP), for example.

In the depicted example, LAN adapter 312, audio adapter 316, keyboard and mouse adapter 320, modem 322, read only memory (ROM) 324, hard disk drive (HDD) 326, CD-ROM driver 330, universal serial bus (USB) ports and other communications ports 332, and PCI/PCIe devices 334 may be connected to ICH 310. PCI/PCIe devices may include, for example, Ethernet adapters, add-in cards, PC cards for notebook computers, etc. PCI uses a cardbus controller, while PCIe does not. ROM 324 may be, for example, a flash basic input/output system (BIOS). Hard disk drive 326 and CD-ROM drive 330 may use, for example, an integrated drive electronics (IDE) or serial advanced technology attachment (SATA) interface. A super I/O (SIO) device 336 may be connected to ICH 310.

An operating system runs on processor 302 and is used to coordinate and provide control of various components within data processing system 300. The operating system may be a commercially available operating system such as AIX®. An object oriented programming system, such as the Java® programming system, may run in conjunction with the operating system and provides calls to the operating system from Java® programs or applications executing on data processing system 300.

Instructions for the operating system, the object-oriented programming system, and applications or programs are located on storage devices, such as hard disk drive 326, and may be loaded into main memory 304 for execution by processor 302. The processes of the present invention may be performed by processor 302 using computer implemented instructions, which may be stored and loaded from a memory such as, for example, main memory 304, memory 324, or in one or more peripheral devices 326 and 330.

Those of ordinary skill in the art will appreciate that the hardware in FIG. 3 may vary depending on the implementation. Other internal hardware or peripheral devices, such as flash memory, equivalent non-volatile memory, or optical disk drives and the like, may be used in addition to or in place of the hardware depicted in FIG. 3. Also, the processes of the present invention may be applied to a multiprocessor data processing system such as that described with reference to FIG. 2.

Data processing system 300 may be a personal digital assistant (PDA), which is configured with flash memory to provide non-volatile memory for storing operating system files and/or user-generated data. The depicted example in FIG. 3 and above-described examples are not meant to imply architectural limitations. For example, data processing system 300 also may be a tablet computer, laptop computer, or telephone device in addition to taking the form of a PDA.

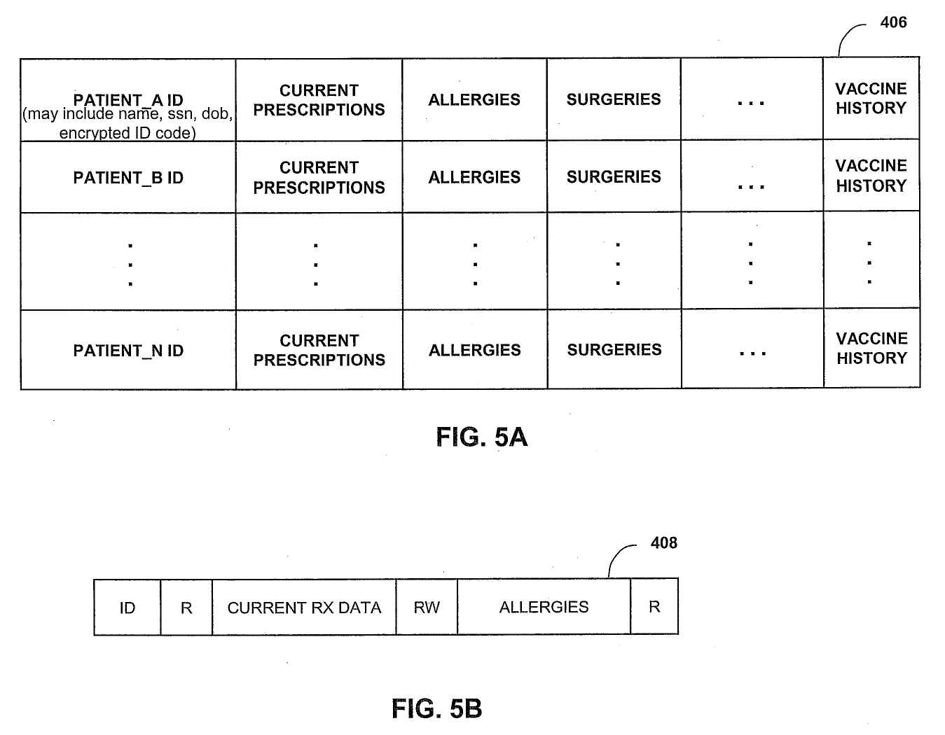

With reference to FIG. 4, there is illustrated a block diagram depicting in greater detail an exemplary architecture of medical records management system 100. As shown in FIG. 4, medical records server 104 includes an access manager module 405 that performs several functions related to providing secure, distributed access to medical record data within medical records database 112. FIG. 5A provides a more detailed illustration of medical records 406 such as may be included within medical records database 112 in accordance with one embodiment of the present invention. Medical records 406 generally comprising multiple row-wise patient medical record entries. Each of the row-wise patient records includes medical record data represented in the figure as column-wise categorized. For example, each of patient records includes a patient ID field as well as fields specifying prescription data, allergies data, surgeries, vaccinations, etc.

FIG. 4 further depicts multiple patient client nodes 102a-102n communicatively coupled to medical records server 104, and each having respective user login modules 404a-404n. As depicted and explained below with reference to FIGS. 5-10, access manager 405 receives account control information in the form of access authorization accounts that specify access parameters relating to patients' medical records. An access authorization account may be embodied by one or more access authorization objects 416 generated by user login modules 404. An access authorization object specifies conditional access grants to medical records for specified patients.

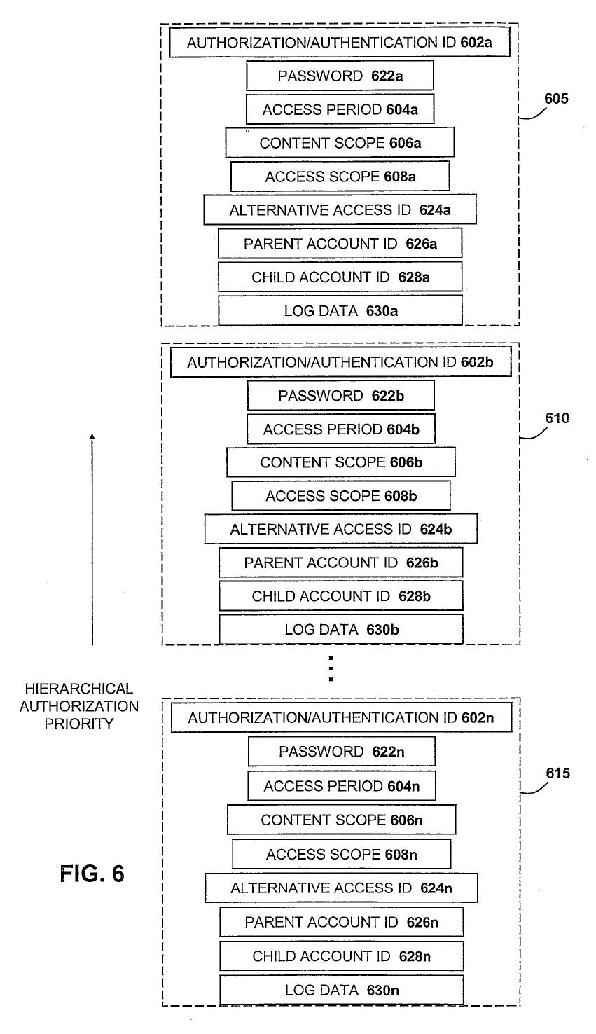

In one aspect, the present invention is directed to providing a user-centric, top-down medical records access mechanism in which a single “top-level” access authorization entity, such as a patient client node, can set access/restrictions in a comprehensive yet flexible manner. To this end a preferred embodiment of the invention implements hierarchically determined and recursively limited authorized access to medical records. A key feature enabling such top-down access control is the structure of processing of the access authorization objects. FIG. 6 depicts this feature represented as a high-level block diagram showing recursive authentication/authorization of access to medical records as implemented by the hierarchical structuring of multiple access authorization objects that specify access authorizations for a given patient's medical records.

Specifically, FIG. 6 illustrates multiple access authorization objects including hierarchically arranged object 605 at the top of the hierarchy and object 615 at the lowest level in the hierarchy. Each of access authorization objects 605-615 includes access parameters including an authorization/authentication field 602, an access period field 604, a content scope field 606, and an access scope field 608. Access authorization objects 605-615 further include a password field 622, an alternative access ID field 624, a parent account ID field 626, a child account ID field 628, and a log data field 630. Each of the access parameter fields includes access authorization limitations/restrictions set by a given access authorizer such as the patient or a medical provider.

Generally, access authorization object 605 is the top-level object typically generated directed by the patient or with the patient's immediate and directly verifiable consent. The access parameters contained in fields 602a, 622a, 604a, 606a, 608a, 624a, 626a, 628a, and 630a specify the top-level and highest priority restrictions and authentication criteria for access to the patient's records. Access authorization objects 610-615 specify access parameters for what are effectively successive sub-accounts of the top-level authorization account embodied by top-level access authorization object 605. The sub-account objects 610-615 may only be generated, such as at one of provider client nodes 116, 118, and 120, in accordance with authorization specified by a higher-level access authorization account/object. For example, the content scope and access scope fields 606b and 608b of sub-account object 610 are restricted in accordance with the content scope and access scope authorizations specified by the corresponding content scope and content access fields 606a and 608a of top-level object 605 but not those of objects below 610 including object 615. Similarly, sub-account access authorization objects beginning with object 610 specify an access period may only be modified to fall within the access period specified in higher-level access authorization objects.

The access authorization hierarchy is established in accordance with authorization granted in the fields 622, 624, 626 and 628. Password field 622, which in one embodiment may be incorporated into authorization field 602, contains the password code required to access the access authorization object. Alternative access ID field 624 contains code(s) utilized to link the account to the accounts embodied by the respective sub-account objects such as those generated by an authorized doctor or guardian account. The linkage is established in accordance with the authorization/authentication data contained in a parent account to provide automatic linking and retention of the sub-account's ID and password authorizations for accounts lower in the hierarchy. The account may be a patient's account or a patient's sub-temporal account or sub-accounts at various levels below the first sub-account. The sub-account ID can be used to log in independently outside of the system such as by using a web interface. The sub-account may also be used to log in automatically with a physician or lab primary ID linked into the system using the depicted recursive account hierarchy. The access period specified by access period fields 604 for the next sub-account may not exceed the bounds of the period specified in the immediate higher level account (i.e. parent account). Similarly the content and access scope specified by contend and access scope fields 606 and 608 for the next sub-account may not exceed the bounds of the access scope (e.g. read/write permissions) specified in the parent account(s).

Parent account ID field 626 contains data identifying the parent account utilized to generate the account while child account ID field 628 contains data identifying recursively generated child sub-account(s). Each account includes log data that logs related to the present account and all authorized sub-accounts. To this end, log data filed 630 contains such log data for all recursively authorized sub-accounts and further includes features such as flag field that can be utilized to revoke, monitor, and/or modify all authorized sub-accounts.

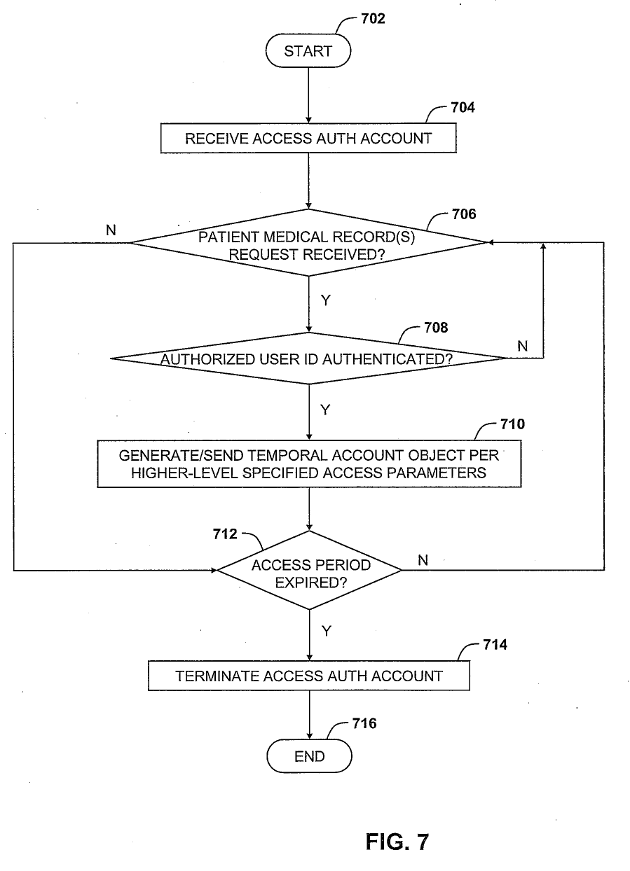

Referring back to FIG. 4, responsive to receipt and verification of the access authorization objects 416 from one or more of user login modules 404a-404n, access manager 405 implements the access control limitations specified by the authorization objects with respect to medical records specified by the objects. The specified access control limitations are incorporated into what will be referred to herein as a temporal account or temporal account object 408. Access manager 405 further establishes one or more sub-accounts for each of the top level accounts authorized by access authorization objects 416. The access control limitations incorporated into the temporal accounts and sub-accounts 408 are imposed by access manager 405 to restrict the scope of content as well as temporal and other condition limitations on a requester client 415 to the data from medical records database 112. Requestor client 415 may represent requester client applications deployed from any of provider client nodes 116, 118, and 120 depicted in FIG. 1. As explained below with reference to FIG. 7, requester client 415 may request medical record data such as from electronic medical records 406 within medical records database 112.

Medical records management system 100 further comprises access and security management and control logic that may include various hardware, firmware, and software programming and functional control modules. Included among and incorporating many of such modules is access manager 405. Server and network connectivity incorporated within medical records server 104 enables access manager 405 to communicate with multiple patient client nodes 102a-102n as well as with requester client 415, which may be a patient or provider client node. As its name implies, access manager 405 manages access to medical records database 112 which comprises hardware and programming with storage media and logic for electronically storing electronic medical records 406 for one or more patients. Each of electronic medical records may comprise medical history, prescription data, current diagnoses, medical charts, as well as other health or medical related information for a specified patient. In one embodiment, some or all of the data contained in electronic medical records 406 include data protected under HIPAA or other legal or regulatory guidelines, consequently requiring restricting access to that content.

In one embodiment of the invention relating to a procedure for access electronically stored medical records, a requesting party at requester client 415 may send a request to access a specified patient's medical record data among electronic medical records 406. The requesting party may be, for example, a physician, a pharmacy, a governmental health agency such as the Centers for Medicare and Medicaid Services (CMS), etc. The request is received and initially processed by request handling logic within access manager 405.

Upon receiving a medical record access request from requester client 415, access manager 405 processes an authorization ID code included in the request to determine whether the requesting party has been authorized at one of the levels in the temporal account hierarchy as determined from the authorization data within the stored access authorization objects 416. The code verification validates the record request authenticity and authorization, for example, by correlating patient identification data, such as name, social security number, DOB, etc. with healthcare or account identification information such as provider account numbers or identifiers. Responsive to successful request authorization validation, access manager 405 determines the security or privacy status of the requested electronic medical record. In this aspect, access manager 405 may process access authorization objects 416a-416n received from patient client nodes 102a-102n to determine whether a patient has recorded authorizations relating to the scope of medical record data to be release and the manner and character of access and read/write permissions. For example, one of access authorization objects 416 may include recorded patient authorization to release medical records of a specified patient dated over a specified period (e.g. last two years). Continuing the example, one or more of access authorization objects 416 may record an affirmative non-authorization to release information related to highly sensitive medical issues such as psychiatric treatment, pregnancy, drug or alcohol rehabilitation treatment, and for certain diseases.

Responsive to determining that the pending medical records request is valid and authorized in terms of data scope and requester authorization, access manager 405 accesses medical records database 112 to retrieve the requested record(s) from among electronic medical records 406. To retrieve the patient electronic medical record from medical records database 112, access manager 405 may, for example, identify the record by patient name, social security number, or other identification indicia that may be contained in or derived from record identification data within the original request. Access manager 405 processes one of access authorization accounts to generates a corresponding temporal account object 408 which is sent to requester client 415. Temporal account object 408 contains medical record data for a patient's medical records within electronic medical records 406 for which access has been authorized by one of access authorization objects 416a-416n. Limits on access authorization may include limitations on the scope of medical record data included in the temporal account object 408 as well as data access limitations (e.g. read/write permissions) and a time period limitation. Characteristics of exemplary temporal account object 408 are depicted in further detail below with reference to FIG. 5B. If access manager 405 determines that the request from requester client 415 is in some way invalid, due to a lack of upper level authorization or otherwise, the request from requester client 415 is denied.

FIG. 5B provides a more detailed depiction of temporal account object 408 generated by access manager 405 using validated request parameters in accordance with one embodiment of the present invention. As shown in FIG. 5B, temporal account object 408 comprises fields including a patient ID field, a current prescription data field, and allergies field. Temporal account object 408 further includes data access restrictions in the forms of read/write permission flags associated with each of the data fields.

Responsive to either a successful or unsuccessful validation of the medical record request from requester client 415, access manager 405 classifies and records the pending (if validation successful) or terminated (if validation unsuccessful) event. In one embodiment, access manager 405 may set a flag in relation to received access request to indicate the status of the request as having been validated and pending or invalid and terminated. Such access request status information may be stored and maintained for a temporally-specified or event-defined period. The recorded access request information may, for example, be stored to maintain a traceable history log of the request and response cycle for audit or other information protection reasons.

Medical records management system 100 may therefore receive, process and store access authorization data from access authorization objects 416a-416n relating to present and future accessibility of specified electronic medical records 406. Access manager 405 ensures compliance with the access authorization requirements set forth by access authorization objects 416a-416n by first authenticating a given access request and then restricting the scope and temporal availability of the medical records data in accordance with the restrictions defined by the authorization objects. In this manner, access manager 405 performs the dual function of validating and fulfilling medical record data requests for authorized and therefore valid purposes. A medical records request from requester client 415 may seek particular data or classes of data, such as, for example, data relating to a patient's vaccination history over a specified period.

FIG. 7 is a high-level flow diagram depicting steps performed by components within medical records management system 100 during a medical record access sequence in accordance with one embodiment of the present invention. The process begins as shown at steps 702 and 704 with access manager 405 receiving an access authorization account/object, such as one of objects 416a-416n, from a client node. As depicted and described above with reference to FIG. 6, the received access authorization object is either the top-level object or is the latest sub-account object such as may be generated by a physician seeking to authorize access to a laboratory. Access manager 405 maintains the received account access object pending receipt of one or more medical record requests for records pertaining to the same patient or until the access period specified in the object expires (steps 706 and 712).

In response to receiving a request for one or more medical records of the specified patient, access manager 405 validates the request by authenticating a user ID and password code received in the access request (steps 706 and 708). In a preferred embodiment, the authorized user identification specified by the access authorization account received at step 704 includes a user identification code and a password code. The user identification code identifies the particular person or entity to which access authorization is to be granted, while the password serves as a security feature ensuring hierarchical integrity between the presently received sub-account object and its originating top-level account. In this embodiment in which the received access authorization object is a sub-account object, the user identification code may be different from the user identification code specified in the top-level access authorization object while, in contrast, the password code is not modifiable from the password code specified in the top-level object.

Responsive authenticating the user ID authorized by the received access authorization account, access manager 405 generates temporal account object 408 in accordance with access parameters, such as those shown in FIG. 6, required by whichever access authorization account accommodates the access request parameters (steps 708 and 710). As depicted at steps 712, 714 and 716, the process of receiving access requests and comparing the request data with access authorization parameters continues until the access period specified by the access authorization object expires and the object account is terminated accordingly.

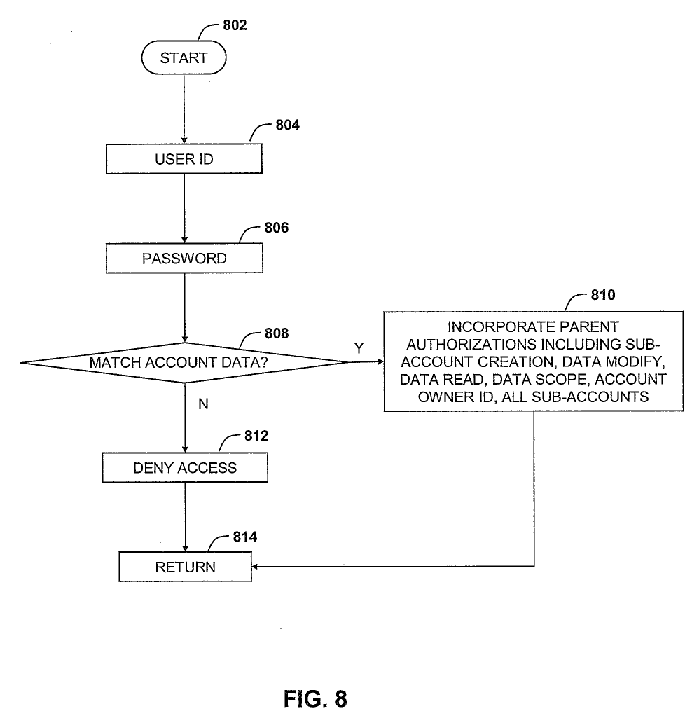

FIG. 8 is a high-level flow diagram illustrating sub-account authentication and authorization in accordance with the invention. The process begins as shown at steps 802, 804, and 806 with the system receiving a user ID and password as part of a request to access the sub-account. In response to the user ID and password not matching authorizations contained in the parent account, access to the sub-account is denied and the process returns as illustrated at steps 808, 812, and 814.

If the user ID and password are found by the access manager to match authorizations contained in the parent account, access to the sub-account is permitted. As shown at step 810 the permitted access incorporates limitations imposed by the identified parent account and may include sub-account creation authority, data modification restrictions, as well as other restrictions. Following sub-account authorization, the process returns as illustrated at step 814.

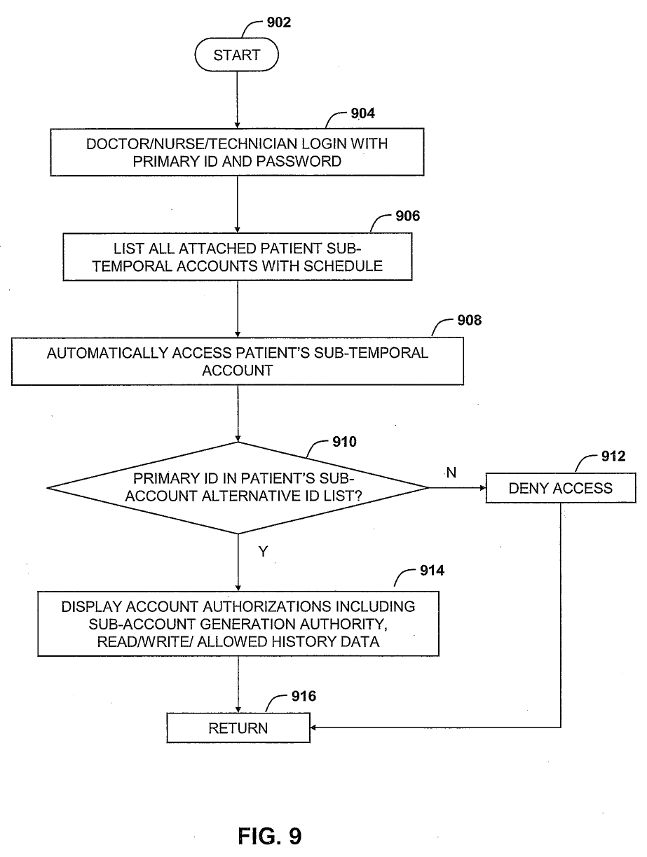

Referring to FIG. 9, there is illustrated a high-level flow diagram depicting dependent automatic batch authentication and authorization using temporal accounts in accordance with the invention. The process begins as shown at steps 902 and 904 with a healthcare provider (e.g. physician, nurse, lab tech, etc.) logging in to the system using a primary user ID and password. The primary user ID and password potentially enable the healthcare provider to access multiple attached patent sub-temporal accounts including associated schedules which are preferably listed prior to and as a user aid for locating the desired patient's records prior to the login sequence (step 906). As shown at steps 908 and 910 the primary ID and password utilized at step 904 enable the provider to automatically access a patient's sub-temporal account provided the account includes authorization associated with the primary ID and password. If so, the account authorizations are displayed and the process returns as shown at steps 914 and 916. If not, access is denied and the process returns as depicted at steps 912 and 916.

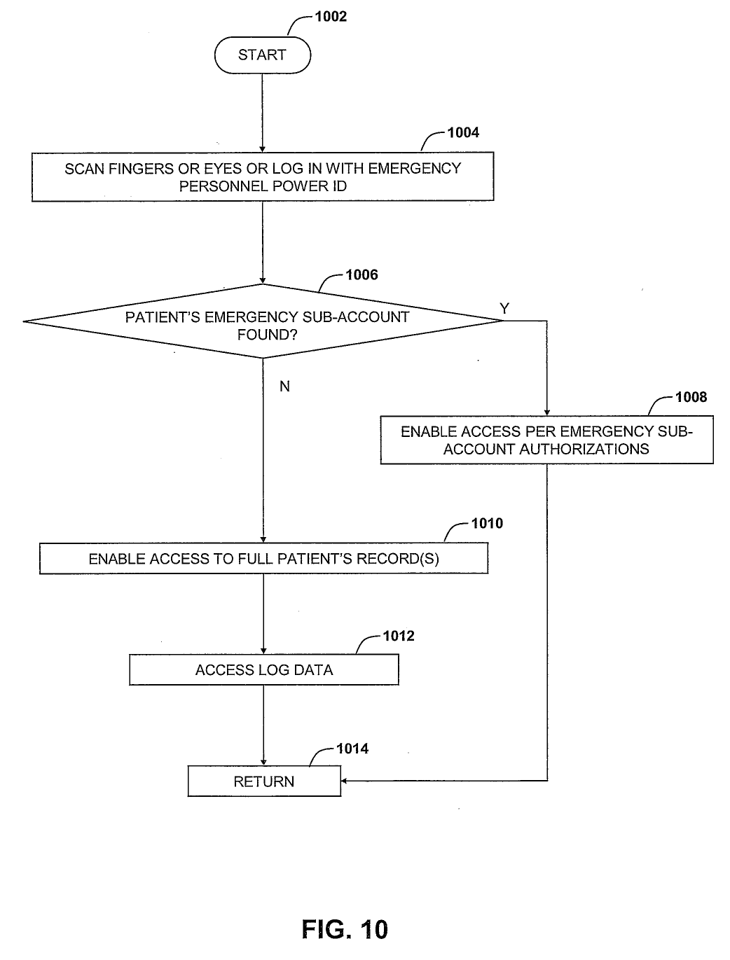

With reference to FIG. 10, there is depicted a high-level flow diagram illustrating emergency personnel authentication and authorization in accordance with one embodiment of the present invention. As shown at steps 1002 and 1004, the process begins with determination of the identity of an emergency medical provider. In a preferred embodiment, the determination may be performed using biometric ID techniques such as retinal or fingerprint scans performed by an identification verification device associated with a user login module.

Assuming a successful login, the process continues with a determination of whether the patient's emergency sub-account with its encoded authorizations may be found or otherwise accessed (step 1006). If not, the emergency access feature of the present invention enables access to the full patient's medical records as authorized by the emergency personnel identification step as shown at step 1010. In response to access the patient's records, the access log data, such as that described above with reference to FIG. 6 is accessed and the process returns (steps 1012 and 1010). If the patient's emergency sub-account with its encoded authorizations are found, access to the records is enabled via an emergency sub-account authorization within the patient's accounts as shown at step 1008.

The disclosed methods may be readily implemented in software using object or object-oriented software development environments that provide portable source code that can be used on a variety of computer or workstation hardware platforms. In this instance, the methods and systems of the invention can be implemented as a routine embedded on a personal computer such as a Java or CGI script, as a resource residing on a server or graphics workstation, as a routine embedded in a dedicated source code editor management system, or the like.

While the invention has been particularly shown and described with reference to a preferred embodiment, it will be understood by those skilled in the art that various changes in form and detail may be made therein without departing from the spirit and scope of the invention. These alternate implementations all fall within the scope of the invention.

What is claimed is:

1. A method for providing secure access to a patient's medical records, said method comprising:
receiving an access authorization account that specifies access parameters relating to the patient's medical records, said access authorization account specifying:
an authorized user identification that specifies one or more user identification codes that may be utilized to access the patient's medical records;
content scope authorization that specifies the scope of data content within the patient's medical records that is accessible using the authorized user identification;
access scope authorization that specifies the extent to which the accessible data content is modifiable using the authorized user identification; and
an access period that specifies an access termination time; and
processing the access authorization account to determine and implement limited access to the patient's medical records.

2. The method of claim 1, wherein said access authorization account further specifies a temporal authentication having temporal account identification data and a temporal password for accessing a subset of account content with subset of access authorization within a subset of the access period.

3. The method of claim 1, wherein integrated temporal accounts are automatically authenticated and authorized by the access authorization account.

4. The method of claim 1, wherein the medical records access authorization account is a top-level medical records access authorization account that provides patient authorization of access parameters relating to a patient's medical records.

5. The method of claim 1, wherein the access authorization account is an access authorization sub-account that may only be generated in accordance with authorization specified by a higher-level access authorization account for the same patient's medical records.

6. The method of claim 5, wherein the content scope and content access authorizations specified by the access authorization sub-account are restricted in accordance with the content scope and content access authorizations specified by the higher-level access authorization account.

7. The method of claim 1, wherein the authorized user identification specifies a user identification code and a password code.

8. The method of claim 7, wherein the access authorization account is an access authorization sub-account descended from a top-level access authorization account for the same patient's medical records, and wherein the user identification code is modifiably different from a user identification code specified in the top-level access authorization account and the password code is not modifiable from the password code specified in the top-level access authorization account.

9. The method of claim 1, wherein the access authorization account is an access authorization sub-account descended from a top-level access authorization account for the same patient's medical records, and wherein the specified access period may only be modified to fall within the access period specified in the top-level access authorization account.

10. A system for providing secure access to a patient's medical records, said system comprising:
means for receiving an access authorization account that specifies access parameters relating to the patient's medical records, said access authorization account specifying:
an authorized user identification that specifies one or more user identification codes that may be utilized to access the patient's medical records;
content scope authorization that specifies the scope of data content within the patient's medical records that is accessible using the authorized user identification;
access scope authorization that specifies the extent to which the accessible data content is modifiable using the authorized user identification; and
an access period that specifies an access termination time; and
means for processing the access authorization account to determine and implement limited access to the patient's medical records.

11. The system of claim 10, wherein said access authorization account further specifies a temporal authentication having temporal account identification data and a temporal password for accessing a subset of account content with subset of access authorization within a subset of the access period.

12. The system of claim 10, wherein the medical records access authorization account is a top-level medical records access authorization account that provides patient authorization of access parameters relating to a patient's medical records.

13. The system of claim 10, wherein the access authorization account is an access authorization sub-account that may only be generated in accordance with authorization specified by a higher-level access authorization account for the same patient's medical records.

14. The system of claim 13, wherein the content scope and content access authorizations specified by the access authorization sub-account are restricted in accordance with the content scope and content access authorizations specified by the higher-level access authorization account.

15. The system of claim 10, wherein the authorized user identification specifies a user identification code and a password code, and wherein the access authorization account is an access authorization sub-account descended from a top-level access authorization account for the same patient's medical records, and wherein the user identification code is modifiably different from a user identification code specified in the top-level access authorization account and the password code is not modifiable from the password code specified in the top-level access authorization account.

16. The system of claim 10, wherein the access authorization account is an access authorization sub-account descended from a top-level access authorization account for the same patient's medical records, and wherein the specified access period may only be modified to fall within the access period specified in the top-level access authorization account.

17. A tangible computer-readable medium having encoded thereon computer-executable instructions for providing secure access to a patient's medical records, said computer-executable instructions performing a method comprising:
receiving an access authorization account that specifies access parameters relating to the patient's medical records, said access authorization account specifying:
an authorized user identification that specifies one or more user identification codes that may be utilized to access the patient's medical records;
content scope authorization that specifies the scope of data content within the patient's medical records that is accessible using the authorized user identification;
access scope authorization that specifies the extent to which the accessible data content is modifiable using the authorized user identification; and
an access period that specifies an access termination time; and
processing the access authorization account to determine and implement limited access to the patient's medical records.

18. The tangible computer-readable medium of claim 17, wherein said access authorization account further specifies a temporal authentication having temporal account identification data and a temporal password for accessing a subset of account content with subset of access authorization within a subset of the access period.

19. The tangible computer-readable medium of claim 17, wherein the access authorization account is an access authorization sub-account that may only be generated in accordance with authorization specified by a higher-level access authorization account for the same patient's medical records.

20. The tangible computer-readable medium of claim 19, wherein the content scope and content access authorizations specified by the access authorization sub-account are restricted in accordance with the content scope and content access authorizations specified by the higher-level access authorization account.
